(19) United States
(12) Patent Application Publication
(10) Pub. No.: US 2007/0095194 A1
(43) Pub. Date: May 3, 2007

(54) Accessories or actuating elements for, or components of, musical instruments

(76) Inventor: Marlene Moerth, Lassnitzhoehe (AT)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/558,813

(22) PCT Filed: May 27, 2004
(86) PCT No.: PCT/AT04/00186

§ 371 Date: Nov. 15, 2006

(30) Foreign Application Priority Data
May 28, 2003 (AT) GM 377/2003
Jun. 2, 2003 (AT) GM 384/2003
Jun. 2, 2003 (AT) GM 382/2003
Jun. 2, 2003 (AT) GM 379/2003
Jun. 2, 2003 (AT) GM 381/2003
Jun. 4, 2003 (AT) GM 388/2003
Jun. 4, 2003 (AT) GM 389/2003
Jun. 12, 2003 (AT) GM 409/2003
Jun. 12, 2003 (AT) GM 410/2003
Jul. 10, 2003 (AT) GM 494/2003
Aug. 13, 2003 (AT) GM 555/2003
Aug. 13, 2003 (AT) GM 556/2003
Aug. 13, 2003 (AT) GM 558/2003
Aug. 13, 2003 (AT) GM 557/2003
Aug. 13, 2003 (AT) GM 554/2003
Aug. 18, 2003 (AT) GM 563/2003
Aug. 18, 2003 (AT) GM 565/2003
Aug. 18, 2003 (AT) GM 564/2003
Aug. 20, 2003 (AT) GM 578/2003
Aug. 20, 2003 (AT) GM 579/2003
Dec. 30, 2003 (AT) A 2104/2003

(51) Int. Cl. G10D 1/00; B27N 5/00

(52) U.S. Cl. 84/452 R

(57) ABSTRACT

The invention relates to accessory and component and actuating parts, respectively, for and of musical instruments, respectively. According to the invention, it is provided that the parts are formed at least partially, preferably entirely, from titanium or a titanium alloy GRADE 5, preferably TiAl6V4, or from a titanium alloy of material number 3.7165 or 3.7164, respectively.

The invention relates to accessory and component and actuating parts, respectively, for musical instruments.

The invention aims at constructing accessory and component and actuating parts, respectively, for and of musical instruments, respectively, in such a way that said parts will interfere with the vibration behaviour and hence the sound emitted by those instruments as little as possible but will have a positive impact. Furthermore, the durability and handling of the instruments are to be improved.

These objects are achieved by designing said parts according to the characterizing part of claim 1. According to the invention, it is achieved that the tone of an instrument is preserved with the upper harmonics and brilliance and carrying capacity are increased; the positive result is well audible. The response of the instrument as well as the brilliance and carrying capacity of the tone are improved, since those parts cause virtually no damping of vibrations and upper harmonics.

Due to the features of claim 3, the advantages are achieved even more explicitly and an almost optimal sound quality, especially sound brightening, is obtained. Furthermore, the parts are wear-resistant, inert, they do not cause allergies and are durable.

The design according to the invention is particularly advantageous for the components of musical instruments indicated in the characterizing part of claim 9.

In the drawings, examples of parts designed according to the invention are indicated, however, it goes without saying that only the designations of said parts are relevant for the scope of the invention rather than the actual depiction of these parts, which might be created also in a modified form by a person skilled in the art.

The invention is explained in further detail below by way of the individual parts, with reference to the drawing.

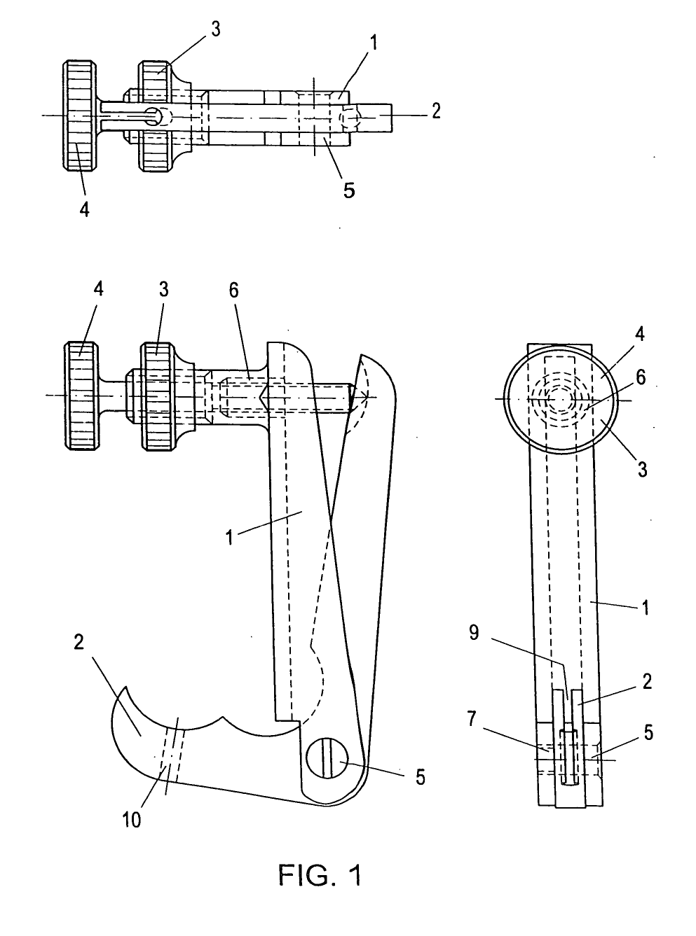

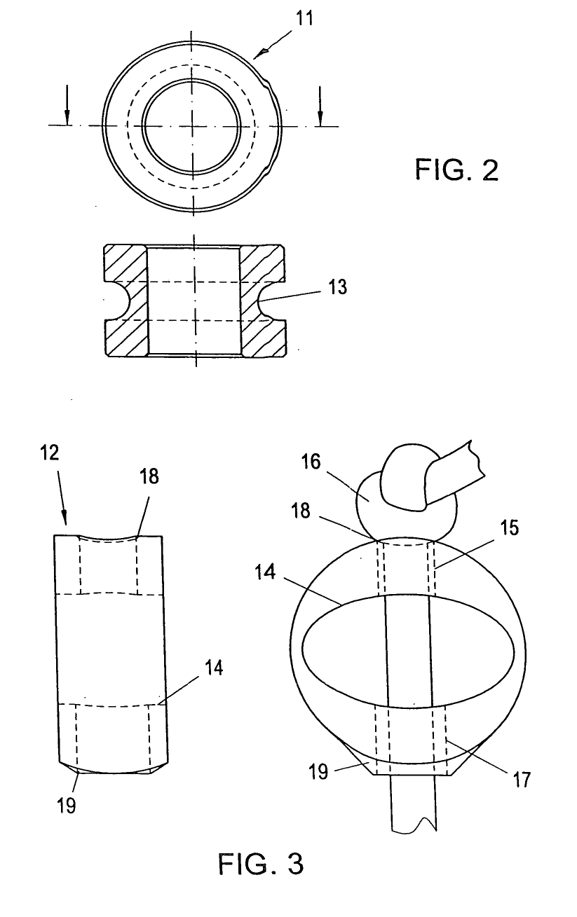

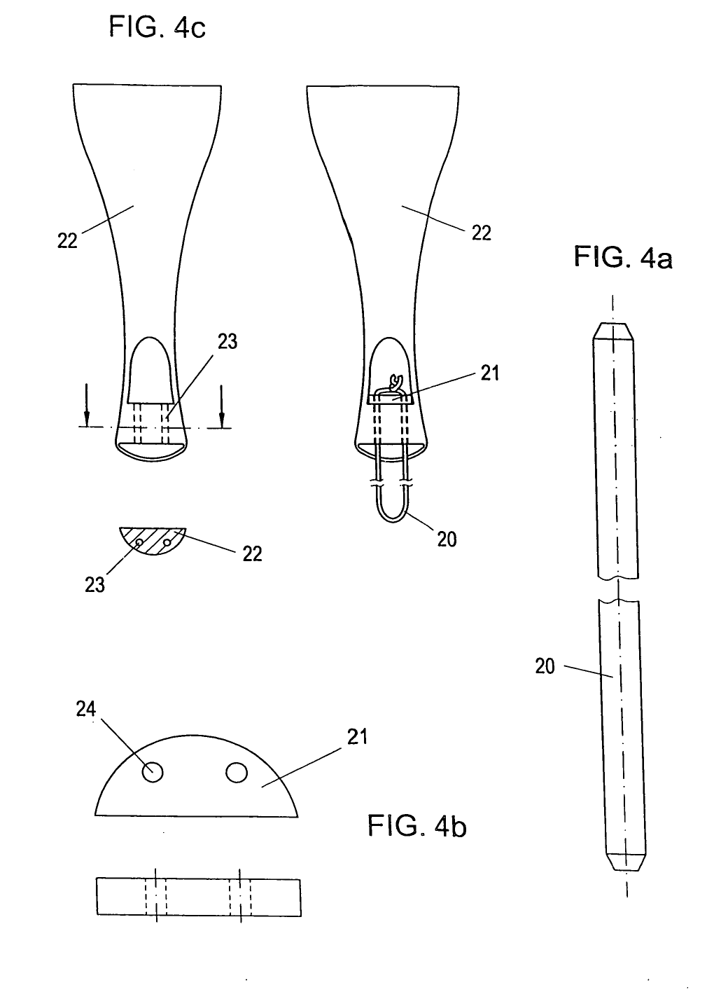

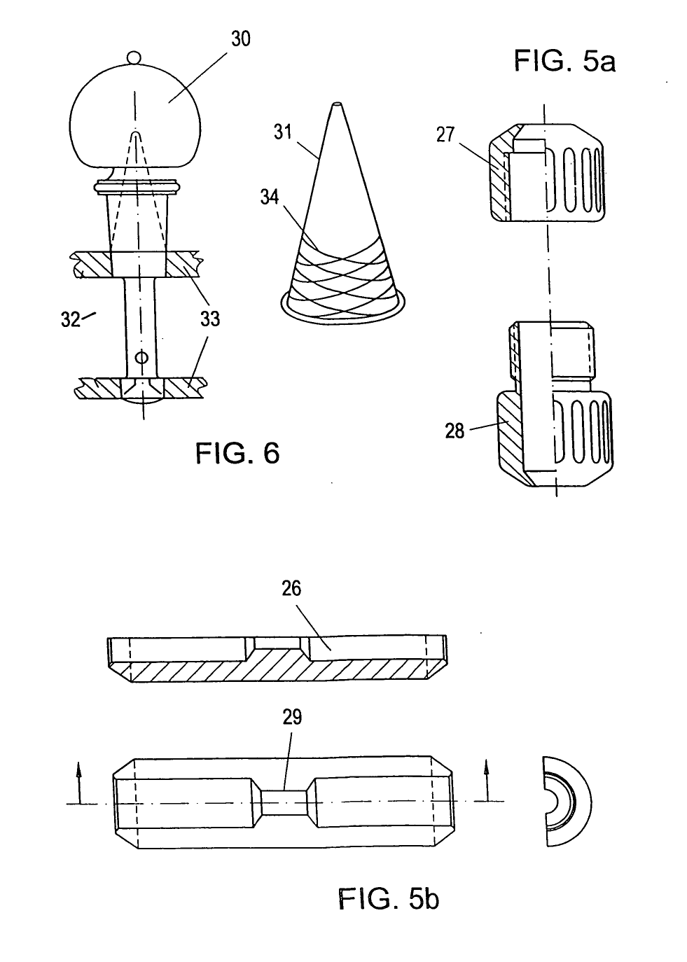

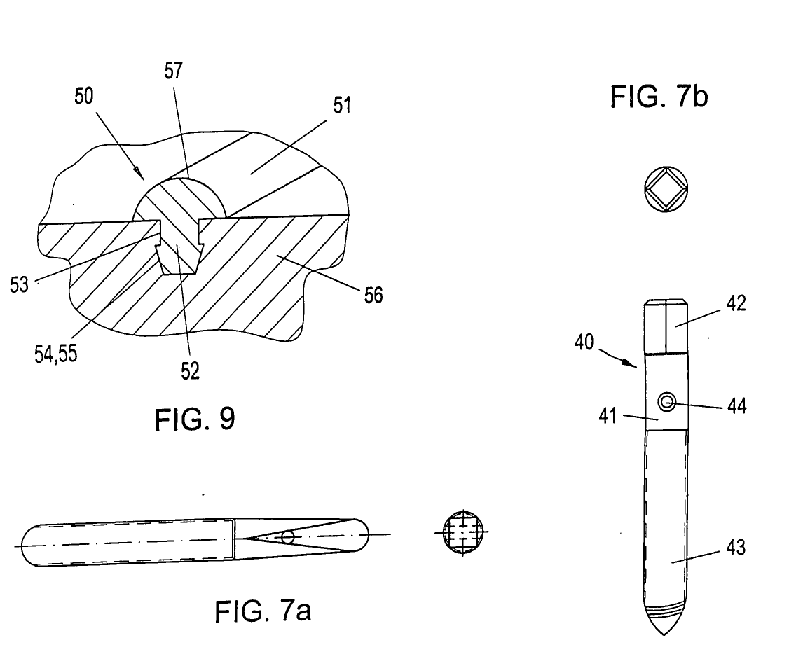

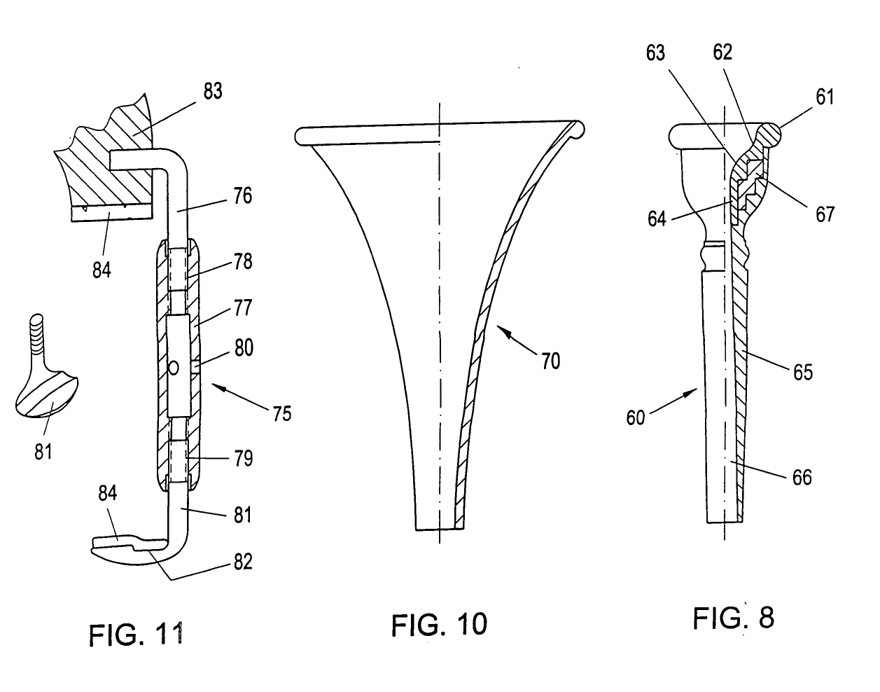

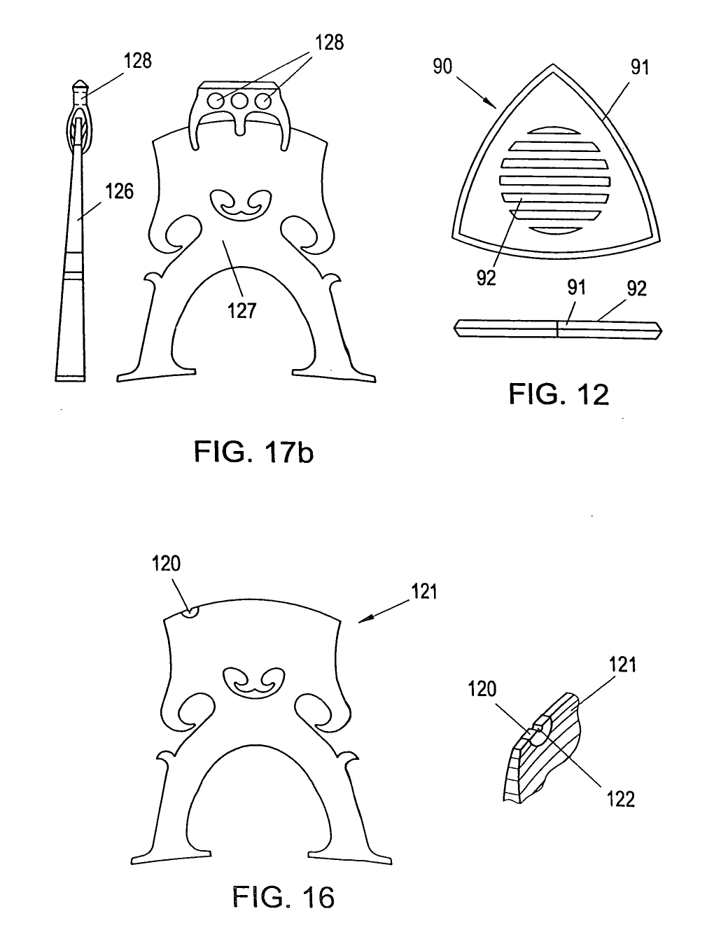

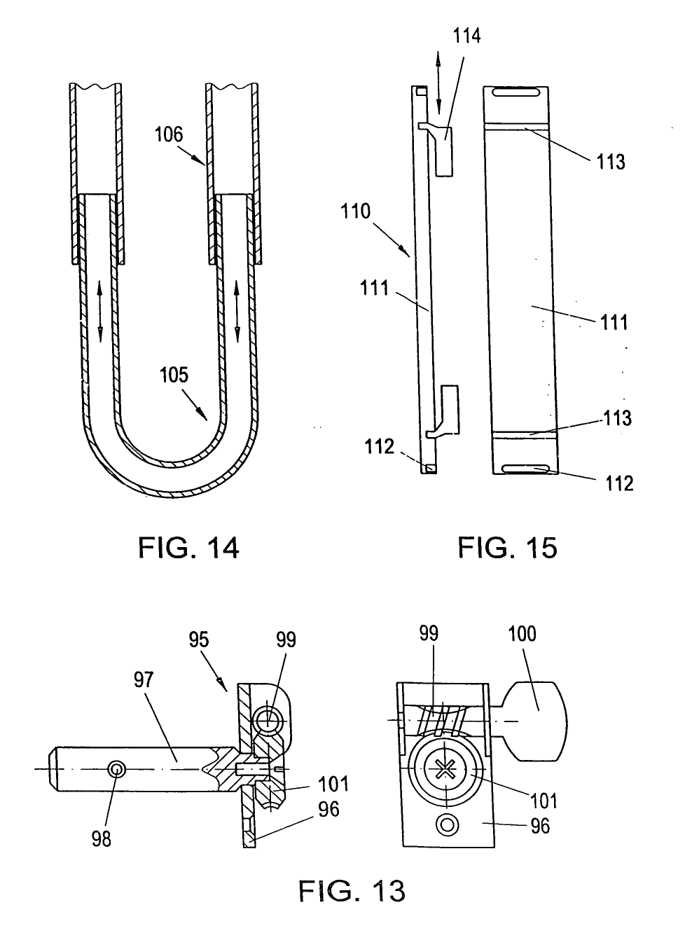

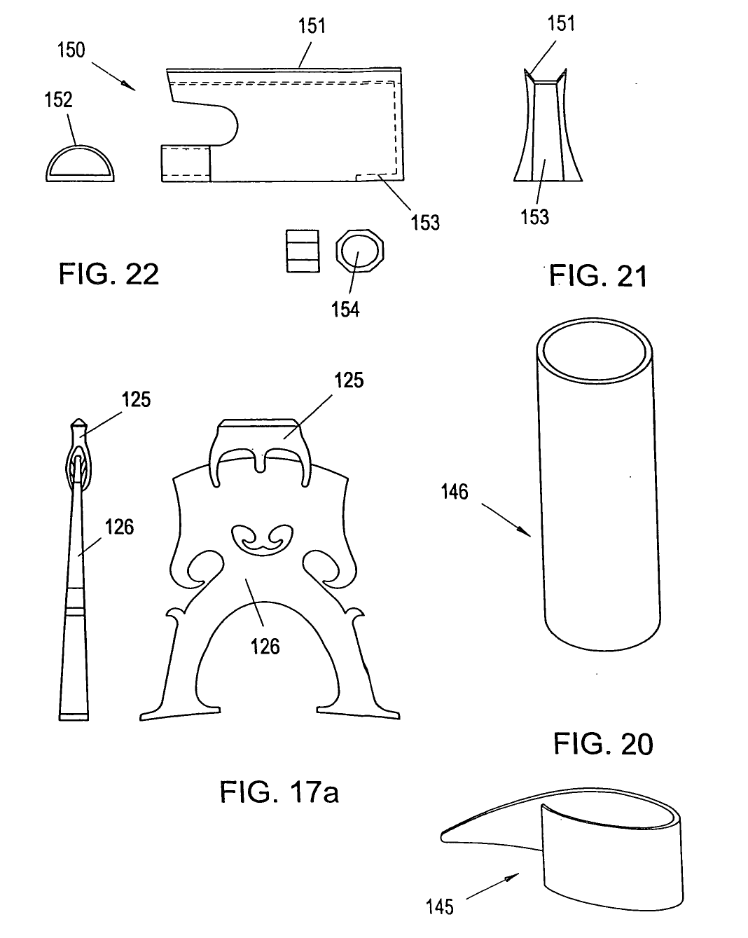

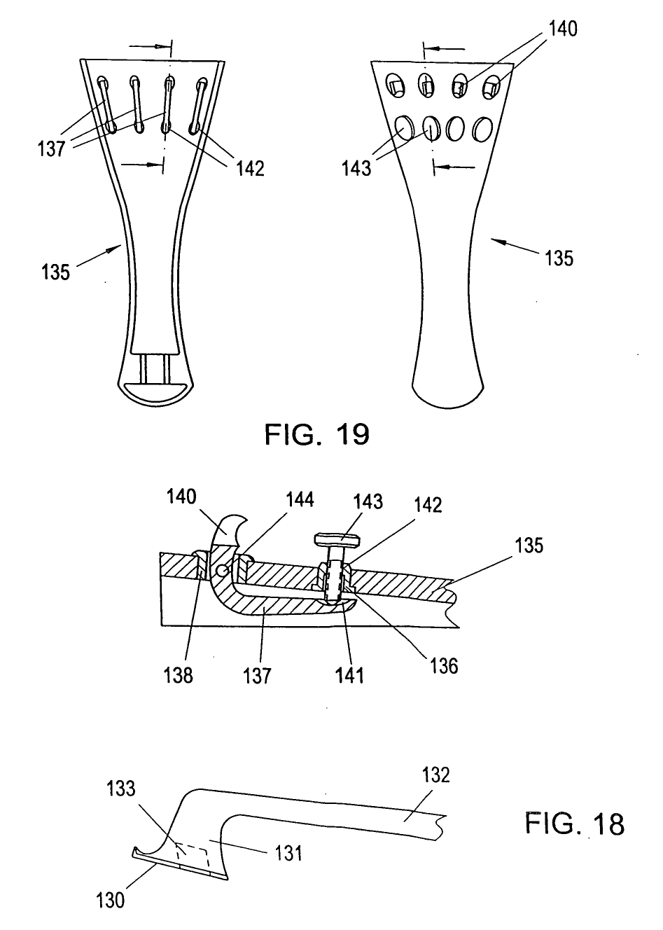

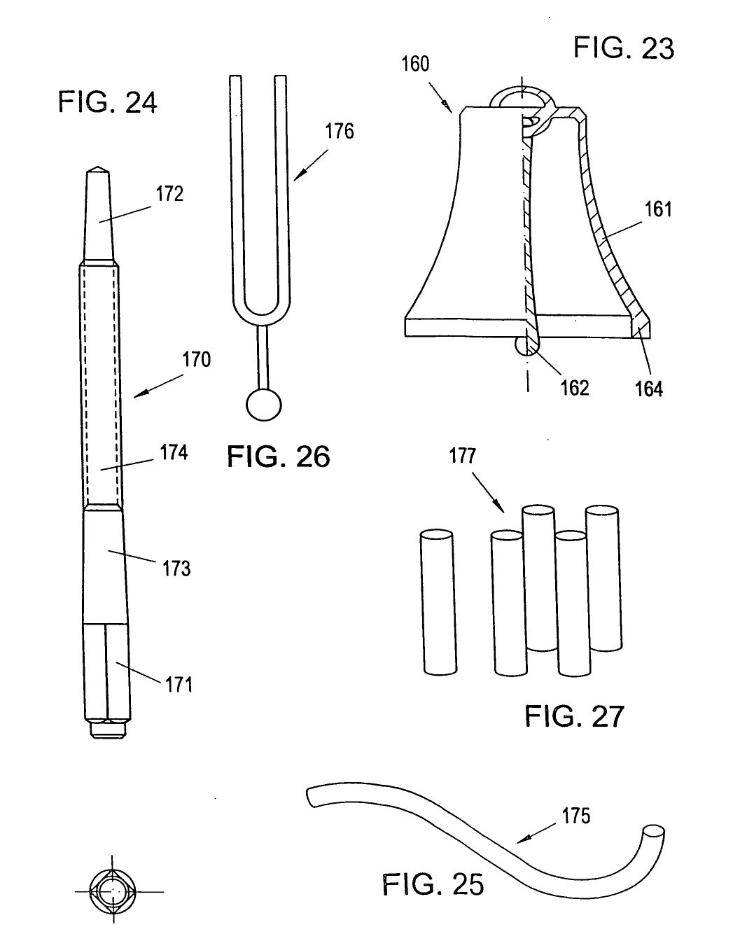

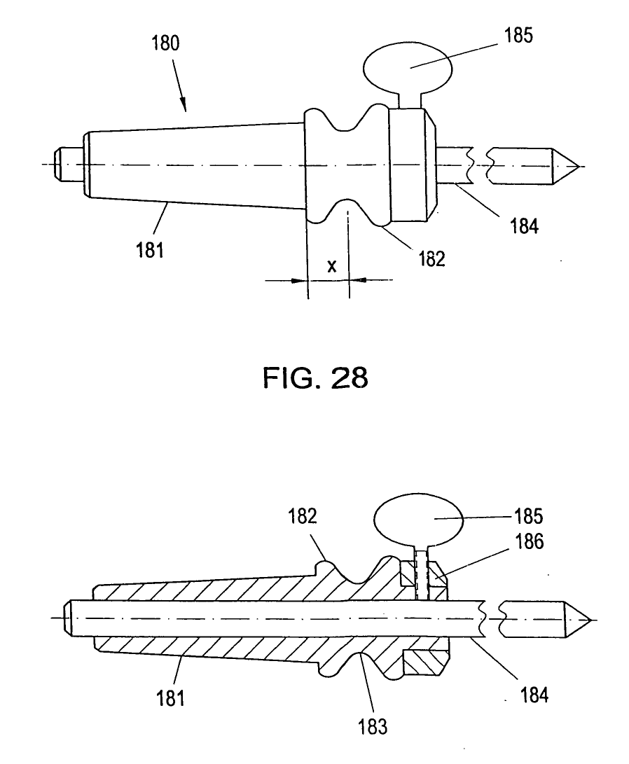

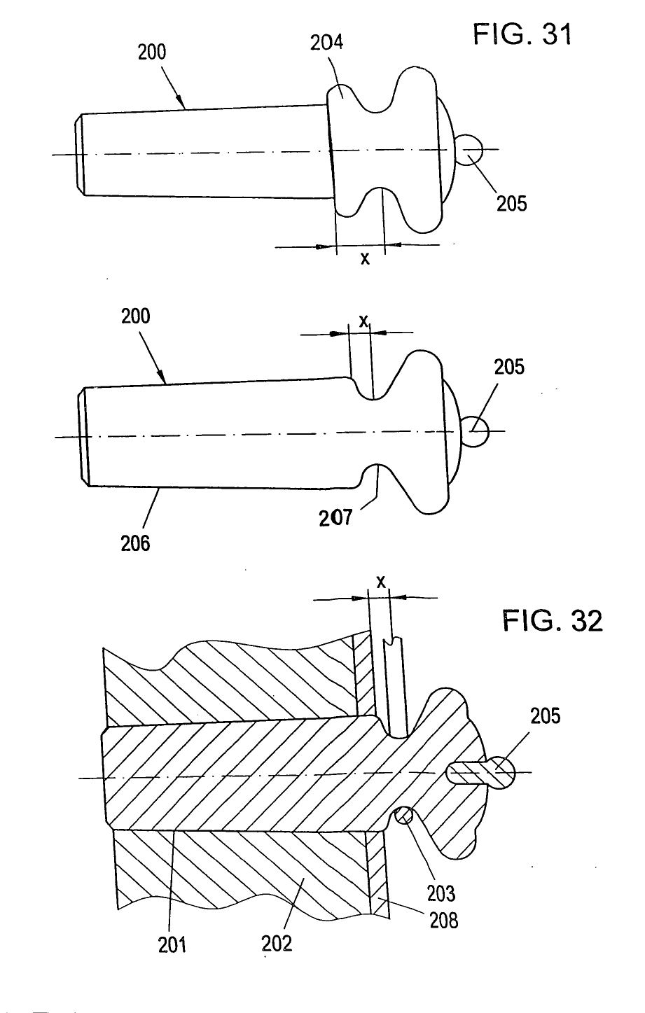

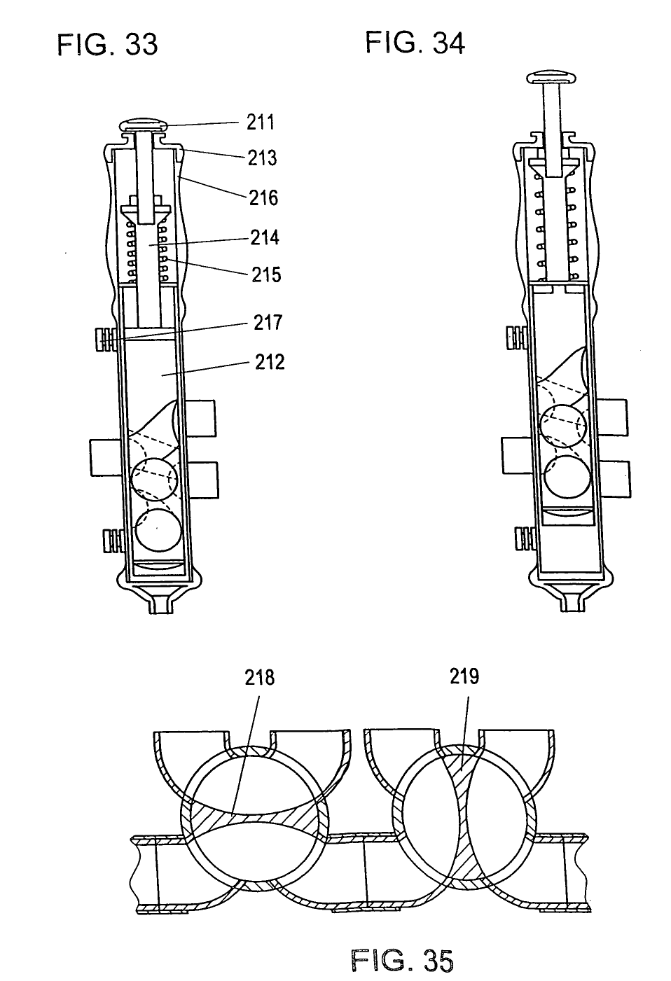

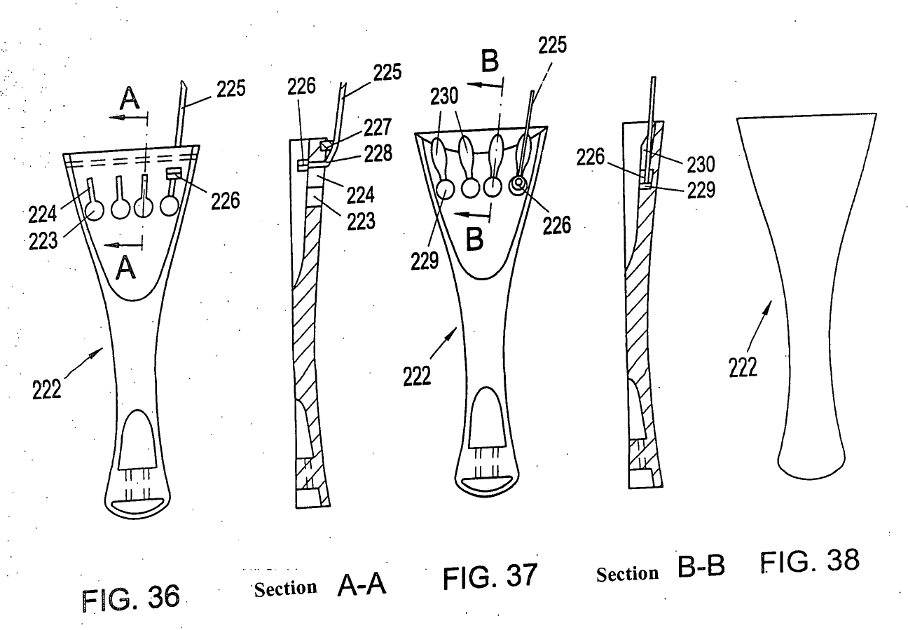

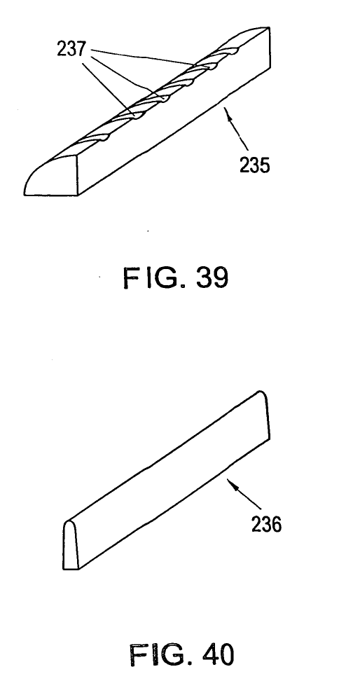

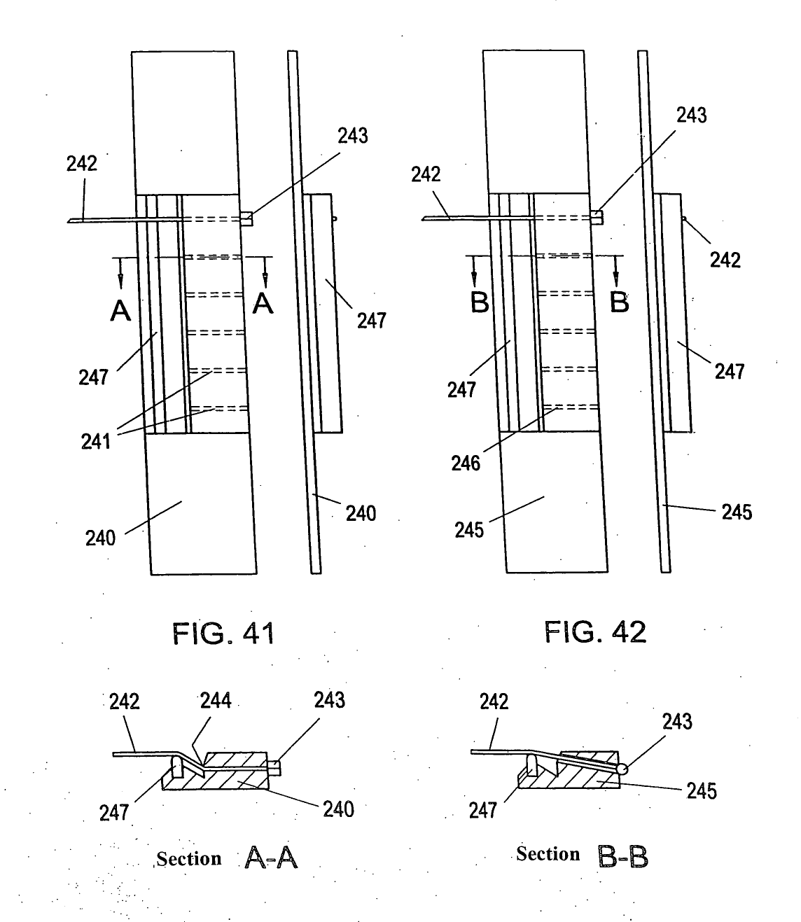

FIG. 1 shows a fine tuner according to the invention; FIGS. 2 and 3 show string balls. FIGS. 4a, 4b and 4c show a tailpiece fastener and a fixing part. FIGS. 5a and 5b show a wolf eliminator. FIG. 6 shows a wooden peg comprising a shaft. FIGS. 7a and 7b show a tuning peg, especially for keyboard instruments. FIG. 8 shows a mouthpiece for brass instruments. FIG. 9 shows a fret, especially for plucked instruments. FIG. 10 shows a bell mouth or sound piece, respectively, for brass instruments. FIG. 11 shows a chin holder screw for string instruments. FIG. 12 shows a plectrum. FIG. 13 shows a mechanism, especially for plucked instruments or string instruments. FIG. 14 shows a trombone slide. FIG. 15 shows laminae of a vibraphone or metallophone, respectively. FIG. 16 shows a bridge support. FIGS. 17a and 17b show mutes for string instruments. FIG. 18 shows a face, especially for string bows. FIG. 19 shows a tailpiece. FIG. 20 shows a thumb or finger ring. FIG. 21 shows a bottleneck. FIG. 22 shows a frog comprising buttons for string bows. FIG. 23 shows a bell. FIG. 24 shows a string bow screw for string bows. FIG. 25 shows a bassoon tube. FIG. 26 shows a tuning fork. FIG. 27 shows a tuning pipe. FIGS. 28 to 30 show an endpin. FIGS. 31 and 32 show a button. FIGS. 33, 34 and 35 show valves; FIGS. 36, 37 and 38 show a tailpiece. FIGS. 39 and 40 show saddles. FIGS. 41 and 42 show bridges.

A fine tuner according to FIG. 1 is a device which is screwed into a tailpiece of a string instrument such as a violin, viola, cello or the like in order to be able to tune the string with greater precision and ease to a particular tone pitch.

The fine tuner illustrated in FIG. 1 and constructed according to the invention comprises, among other things, a microscrew 5 and a thread nut 6 which are provided with hard layers of TiN, WC/C, CrC and/or TiN or exhibit, respectively, on their surfaces at least one hard layer of this kind, whereby a durability and wear resistance is achieved which is substantially improved over the fine tuners which, so far, have been manufactured from iron or from sheet steel and steel screws. Furthermore, the weight and the modulus of elasticity of the materials used cause less damping of the upper harmonics of string instruments. The tone of an instrument is preserved with the upper harmonics and the instrument displays brilliance and carrying capacity, as it would also without a fine tuner, however, without the convenience of easily tunable strings.

The surfaces of the fine tuners according to the invention are non-abrasive because of the hard layers and the material does not cause allergies.

According to FIG. 1, the screw connection part 1 is screwed via a knurled nut 3 into the tailpiece carrying the lever 2 as well as the knurled screw 4, the microscrew 5 and the thread nut 6. All parts, except for the thread nut, are produced according to the invention, i.e., with titanium or with the indicated titanium alloy(s), respectively, and optionally with the indicated hard layers. The thread nut itself is advantageously made of cold-hammered bronze for bearings and bushes which exhibits good emergency running properties.

The knurled nut and the knurled screw carry a flat knurl with a division of 0.5 mm. A threaded stem is placed onto a milled U-profile 1, which threaded stem has a bore for the knurled screw and a bore for the thread nut 6. The external thread of the stem carries the thread of the knurled nut and, on the other end of the U-profile 1, there is a bore with an indentation for the microscrew representing the articulation. On one side, the lever 2 has a slot which ends in the bore 10 and serves for receiving the string, and in the bend it has a bore or recess 7, respectively, for the microscrew 5. A shuttle-shaped recess 8 which serves for guiding the knurled screw is milled into the other end. The slot 9 has variable dimensions, depending on the string to be hooked in.

FIGS. 2 and 3 show string balls 11, 12 constructed according to the invention and serving as abutments for strings of musical instruments which are connected to said string ball. On the tailpiece end of the strings of musical instruments, string balls are used as abutments for tightening the strings. The ball is mounted by placing the string in the form of a loop into a groove 13 of the ball illustrated in FIG. 2 and then by twisting the same with the string and wrapping a thread around it. Since the string ball constitutes the direct transmission point of the impulses, it is essential not to dampen said impulses and the vibrations created. By means of the string ball designed according to the invention, the response of the instrument and the brilliance and carrying capacity of the tone are improved, since a soft alloy causes virtually no damping of vibrations and upper harmonics. By means of the possibly provided hard layers, the brilliance of the tones and the carrying capacity of the instrument are improved further; by anodic oxidation and/or heat treatment, the colouring of the string ball can be predetermined and designed in a pleasant way, respectively, just as with the other accessory parts produced from the alloys according to the invention. Using heat treatment, the quality of sound can be improved further by allowing the alloy to harden appropriately.

FIG. 3 shows an embodiment of a string ball 12 according to the invention. If the string ball 12 is furnished, according to the procedure of the invention, with at least one hard layer, a far better vibration transmission, a more brilliant tone and a longer period of vibration of the strings are obtained. The upper harmonics and thus the transparency of the acoustic patterns are promoted by the high strength of the material and the low density. The wear resistance and corrosion resistance of the string ball is almost boundless. In addition, the material and the coatings are inert and non-abrasive.

These advantages generally apply to all parts designed according to the invention.

The hard layers can be applied in several identical or different layers to the surface of the alloys, whereby the vibration behaviour of the material is influenced in a well audible and pleasant way.

The string ball can have a cylindrical or oval bore 14 as illustrated in FIG. 3 in front and side view, respectively. It is important that the small transverse bore 15 at the knot 16 is only slightly larger than the string in order to be able to hold the knot securely. However, the opposite transverse bore 17 must guarantee the vibration freedom of the string. An indentation 18 is necessary for protecting the string. A turned-on cone 14 serves for the self-centering of the string ball in its bearing in order to facilitate the mounting of the string and to ensure proper functioning. For the recess on the tailpiece or on the bridge, nothing more than a bore with an indentation for the ball or the turned-on cone 19, respectively, is required. The string ball is produced entirely from titanium or the alloy according to the invention.

FIGS. 4a, 4b and 4c show a tailpiece fastener 20 and a fixing part 21 for string instruments. At the narrow end of the tailpiece 22, the tailpiece fastener 20 is put through the two holes 23 in the wood 3 and subsequently through the two holes 24 of the fixing part 21 and is then bent up and twisted. According to the invention, the tailpiece fastener 20 and the fixing parts 21 are produced from titanium or from the indicated titanium alloys—if need be, provided with at least one hard layer—whereby the transmission of impulse vibrations and upper harmonics is improved. Since the tailpiece fastener 20 and the fixing part 21 constitute the direct transmission point of the impulses, vibrations and upper harmonics, it is essential not to dampen said impulses, vibrations and upper harmonics.

The diameter of the tailpiece fastener 20 and of the fixing part 21 is adjusted to the instrument. The alloys can be used particularly well for the intended purpose because of their density, their tensile strength and their modulus of elasticity.

FIGS. 5a and 5b show a wolf eliminator 25 for string instruments. In the wolf eliminator according to the invention, the two halves of a collet chuck 26 are applied axially (FIG. 5b) directly to a string and subsequently the screw sleeves 27 and 28 are screwed together (FIG. 5a), whereby the wolf eliminator, thus consisting of a total of four parts, is clamped onto the string at a particular point between the tailpiece and the bridge. Instead of using damping materials such as rubber, caoutchouc or the like as components of conventional wolf eliminators, the screw sleeves 27, 28 which can be screwed onto the ends of the collet chucks 26 are produced from titanium or from an alloy according to the invention, respectively, whereas pure iridium or pure tantalum, respectively, is used for the collet chucks 26, whereby the transmission of the impulses, vibrations and upper harmonics of a string is not hampered but the wolf tone is neutralized by the vibration node generated.

Pure iridium and pure tantalum, respectively, is used because of the high density of these materials and due to their good sound conductivity.

Since the collet chuck is the direct transmission point of the transmitting string to the mass of the wolf eliminator, it is essential not to dampen the impulses, vibrations and upper harmonics of the string as a result of a direct contact of the string with the wolf eliminator. The diameter of the inner bore 29 of the collet chuck 26 is adjusted to the string. The positive result is well audible, since the response of the instrument during the wolf tone as well as the brilliance and carrying capacity of the tone are substantially improved, since soft materials such as copper, rubber, caoutchouc, plastic or the like cause virtually no damping of impulses, vibrations and upper harmonics. As with the other parts produced according to the invention from titanium or from the titanium alloys according to the invention, respectively, a coating of hard layers can optionally be applied by anodic oxidation and/or age hardening.

FIG. 6 shows a wooden peg 30 comprising a shaft for string instruments. According to the invention, the shaft is produced from titanium or from a titanium alloy, respectively, if need be, coated with hard layers. Such a peg is inserted in a string instrument with its conical shaft 31 into a hole provided therefor, which has been driven conically into the peg channel 32. It is provided that the peg shaft 31 has bearing surfaces produced from titanium, in particular titanium grade 5, or from a titanium alloy, respectively, and is connected to a wooden peg 30. According to the invention, titanium or a titanium alloy, respectively, is used instead of the wood used previously for the peg shaft, whereby the transmission of the impulses, vibrations and upper harmonics of the string via the peg render the instrument body and the instrument, respectively, more precise and clear.

In order to save on weight, it may be provided that the shaft 31 is thinned between the pegbox walls 33, if necessary.

The peg shaft 31 made of titanium or a titanium alloy is glued with a conical surface to the wooden peg having a conical bore. Said conical surface has two grooves 34 in the form of a conical left-hand and an overlapping conical right-hand thread in order to ensure positive bonding. The two grooves are not completely cut as threads with a gradient of 1 mm.

The bearing surface 2 of the peg shaft 31 exhibits a conical fine thread 34 with a gradient of 0.08 mm in order to prevent loosening during the tuning of the peg, i.e., the peg tightens automatically, whereby not only the support of the peg but also the vibration transmission of the peg to the instrument is promoted. Thus, there are two pegs with a conical right-hand fine thread and two pegs with a conical left-hand thread for one instrument. The peg shaft end is provided with a wooden cap 30 for optical reasons.

FIGS. 7a and 7b show a tuning peg 40 for keyboard instruments. Said tuning peg consists of a metal rod 41 which carries a square 42 on one end and a single-start or multi-start fine thread 43 on the other end. In the area between the thread 43 and the square 42, a hole 44, the so-called string hole, 44, is formed. With keyboard instruments, the tuning peg 40 is inserted or driven, respectively, into the pin block, after a slightly smaller hole has been pilot-drilled into the block in order to subsequently wind the strings onto the tuning peg and to be able to tighten, i.e. tune, them. Instead of the iron alloys which have previously been used for such tuning pegs, the alloys according to the invention or titanium, respectively, are provided, if need be, comprising hard layers. In this way, the advantages are achieved which have already been achieved in connection with the other parts of the musical instruments. The diameter and length of the tuning peg 40 are adjusted to the respective keyboard instrument.

In contrast to conventional tuning pegs, the fine thread 43 exhibiting the specific thread profile is not cut or case-threaded but rolled or milled. This has the decisive advantage that the surface is not rough but very smooth and free of burrs and edges and that hence the wood is not machined but only displaced during the knocking-in process, whereby a far better support for the tuning peg is achieved, even if the tuning peg is replaced frequently.

FIG. 8 shows a mouthpiece 60 for brass instruments of all kinds, in particular for trumpets, flugelhorn, horn, tuba, trombone.

The mouthpiece 60 is a rotationally symmetrical pivoted part made of titanium or an alloy indicated according to the invention, comprising an edge 61, a pot 62, a heart 63, a soul 64 and a shaft 65. The bore is referred to as a rod or shaft bore 66.

A ring 67 can be inserted in the mouthpiece; said ring 67 could also be attached or wound, respectively, onto the exterior of the heart 63 and the soul 64, respectively. Preferably, the ring 67 is hot-pressed so as not to interfere with the vibration transmission. The titanium or alloys used, respectively, is/are preferably provided with hard layers and can therefore be set into vibration more easily and produce a brilliant tone rich in upper harmonics. This kind of tone formation is improved by the inserted ring.

The ring 67 must not be glued but, as already mentioned, has to be hot-pressed after having been inserted; a ring wound on from the outside must not be glued but has to be shrunk on.

In the following, a bridge pin for keyboard instruments is described without a separate drawing. A bridge pin according to the invention consists of a round metal rod (length approx. 10 to 15 mm, diameter approx. 2 mm) which has a tip on one end and is composed of titanium or an indicated titanium alloy, if need be, provided with hard layers. In a keyboard instrument, the bridge pin has the function of transmitting the string's vibrations directly to the instrument. The diameter and length of the bridge pin are adjusted to the respective keyboard instrument.

A string designed according to the invention (not illustrated) is produced from titanium or from one of the indicated alloys, respectively, if need be, coated with hard layers. In addition, the string can be electroplated with rhodium or platinum.

The string according to the invention is a non-gimped or ungimped string, respectively, which is provided with a string ball on one end and is inserted into a peg on the other end in order to be clamped onto an instrument in this manner. A string designed according to the invention is far more prone to vibrations and facilitates the response of the instrument. The diameter of the string and the required tension as well as the length are adjusted to the respective instrument. By coating the base material and the hard layers respectively, which have been applied if necessary, with a material of higher density such as rhodium or platinum, the tone becomes more brilliant.

FIG. 9 shows a fret 50 for plucked instruments, in particular comprising a top area 51 and a T-shaped shaft.

The fret for plucked instruments illustrated in FIG. 9 basically has the shape of a T and a shaft 53 provided with retaining teeth 54, 55. The fret 50 is knocked, glued or stuck into a transverse groove of a bridge 56 in order to be able to shorten a string when playing the instrument, thus changing the pitch. Usually, every halftone has a separate fret. The cross-section of a fret is usually shaped like a T, with the top side 57 having a roughly semicircular shape. The fret is incorporated in a finger board of a plucked instrument. The width and length of the fret are adjusted to the finger board. The wear resistance of a fret according to the invention is much higher than that of conventional frets, in particular those made of brass or nickel silver.

FIG. 10 shows a bell mouth 70 or a sound piece, respectively, for brass instruments, in particular trumpets, flugelhorn, horn, tuba and trombones and for signal-horns, hooters, police sirens, respectively.

In order to improve the response, the carrying capacity and brilliance of such instruments, the sound piece or bell mouth, respectively, is produced from titanium or a titanium alloy, if need be, coated with at least one hard layer and optionally anodized or designed in terms of colour and hardness, respectively, via heat treatment.

FIG. 11 shows a chin holder screw 75 for string instruments, in particular fiddles, violins or violas. Chin holder screws are used for attaching the chin holder 1 to the instrument so that the player is able to hold the instrument more easily via a wooden disk, the chin holder 1, without damping the vibrations of the instrument's cover.

A chin holder screw comprises a curved setscrew 76 with two right-hand threads, an inside thread part 77 with a right-hand thread 78, a left-hand thread 79 as well as at least one transverse bore or transverse bores 80, respectively, and a foot 81 with a left-hand thread 79 as well as a clearance 82 for the bottom edge. In order to protect the instrument, the foot 81 and the chin holder 83 are plated with cork 84.

In contrast to conventional materials of brass or steel, which, if need be, are nickel-plated or gold-plated, titanium or titanium alloys are used at best with hard layer coatings. This involves improvements with regard to wear, allergic behaviour as well as the transmission of impulses, vibrations and upper harmonics.

Furthermore, the chin holder screws according to the invention have only three radial inside-thread part bores instead of four like conventional chin holder screws, whereby damage to the ribs is prevented during assembly and disassembly. Furthermore, the internal threads, i.e. the left-hand thread and the right-hand thread, are covered by an initial clearance of the thread in the inside thread part, thereby preventing the musician's hair from getting entangled.

FIG. 12 shows a plectrum 90 for plucked instruments which is composed of titanium or a titanium alloy according to the invention and, if need be, is coated with hard layers. By anodic oxidation or thermal treatment, the plectrum can be designed in terms of colour and strength, respectively, by hardening.

The plectrum 90 is a roughly triangular flat part whose edges 91 are chamfered or rounded. In its centre, the plectrum carries a grip part 92 attached to both sides. Said part can be milled, embossed or cast-on. The plectrum 90 is produced in various strengths, depending on the respective variation and tone.

FIG. 13 shows a mechanism for plucked instruments or string instruments, in particular contrabasses. At least the shaft of the mechanism is composed of titanium or a titanium alloy according to the invention, if need be, coated with hard layers. Advantageously, the entire mechanism consists of titanium, the titanium alloys indicated according to the invention, if need be, comprising hard layers, and hardened by thermal treatment.

Such mechanisms may be designed or used, respectively, for a single string at a time or also for several strings. A mechanism constitutes a device located on the pegbox of a plucked or string instrument, respectively, in particular a contrabass, which usually is permanently mounted on the instrument and is used for tightening and tuning the strings, mostly via a worm gear. Such a mechanism 95 generally comprises a base plate 1, a shaft 2 with a string hole 6, a worm drive 3 with a wing grip 4 and a worm wheel 5. At least the shaft and advantageously at least one further part are produced from titanium or from titanium alloys according to the invention, respectively, if need be, comprising hard layers and optionally treated thermally.

FIG. 14 shows a trombone slide 105 which is designed from titanium or from a titanium alloy indicated according to the invention, if need be, coated with at least one hard layer and optionally treated thermally. Apart from the advantages already mentioned with regard to an improved vibration transmission, a more brilliant tone, non-damping of impulses and upper harmonics and easier response of the instrument, it is possible in this case to increase the speed of extending and retracting and hence the speed of tone alternations via the lower density of the material used and, simultaneously, to improve the wear resistance also against a buckling of the slide. If at least one hard layer is provided, the coefficient of friction is reduced and a more precise and durable pipe of the slide is achieved. At the same time, the wall thicknesses can be reduced, since titanium and the titanium alloys, respectively, used according to the invention are basically more solid and stable than the previously used brass alloys or similar alloys. It is essential for the invention that the pipe and the ducts forming the pipe, respectively, and optionally the bridge consist entirely of titanium or an alloy according to the invention, respectively. If necessary, these components are provided on their surfaces with the hard layers TiN, WC/C, CrC, CrN, wherein, just as with the other parts designed according to the invention, at least one layer is provided or, if need be, also several layers are formed on top of each other.

Connecting the slide 105 designed in this way with the other components of the trombone or with further duct parts 100, respectively, is feasible by laser welding or soldering.

FIG. 15 is a schematic illustration of the design of a vibraphone or metallophone 110, respectively. According to the invention, a vibraphone or metallophone has laminae made of titanium or the indicated titanium alloys, respectively, especially in combination with at least one hard layer. Even in case of very high-pitched tones, a lamina according to the invention achieves a pleasant sound.

The period of vibration of such a lamina 111 can be extended by inserting or attaching, respectively, heavy metal parts 112, especially made of tungsten and/or iridium and/or alloys of these metals, on both ends of the lamina. The support or fixing of the lamina 111 with clamping parts 114 in these grooves 113 formed on both vibration nodes, as illustrated on the left-hand side of FIG. 15, provides the advantage that either the slack or the tight lamina vibrates.

Tongues for accordions, harmonicas and mouth organs of all kinds can be produced from titanium, in particular titanium grade 5, in particular the indicated titanium alloys, if need be, provided with hard layers of the indicated kind, whereby a far better quality of sound is created for the reasons already indicated. The result is, above all, precision and poignancy of the tongue and consequently a fast response; if the instrument is played softly, the abundance of upper harmonics need not be relinquished. Due to the low E-modulus, the harmonica has a longer sound.

The same also applies to tongues used for musical clocks or similar instruments, wherein the tongues which have previously been produced from brass alloys can be replaced by tongues of the kind according to the invention. At the same time, a tongue break is virtually ruled out due to the design according to the invention of such tongues.

Sheets for woodwind instruments of all kinds, in particular for saxophones, oboes, can be produced from titanium, in particular titanium grade 5, or from the indicated alloys, respectively, if need be, comprising hard layers. The wear resistance of such sheets is increased; the precision and poignancy of the tongue and hence a fast response and the possibility to play softly, without having to relinquish the abundance of upper harmonics, are thus feasible. At the same time, the material used is inert and non-abrasive and does not cause allergies. Furthermore, common reeds change their vibration behaviour due to moisture, especially saliva and exhaled air. In contrast to reeds, the sheets according to the invention are resistant to moisture and corrosion. At the blade, the sheets according to the invention are far more sharp-edged than reeds, and the carving of the reeds can be omitted.

FIG. 16 is a schematic illustration of a bridge support 120. Such bridge supports 120 are placed onto a bridge 121 or inserted into the same, respectively. The bridge supports 120 are provided for string instruments of all kinds in order to prevent the strings from caving in on the bridges. Plastic tubes, strips of vellum or wooden inserts, which are placed across the bridge in order to prevent the strings from caving in, are replaced by bridge supports according to the invention.

A bridge according to the invention comprises bridge supports made of titanium or the indicated titanium alloys, respectively, optionally coated with hard layers.

In the design according to the invention of the bridge supports or of a bridge, respectively, a string is prevented from caving in and hence, on the one hand, the string is allowed to vibrate freely and, on the other hand, the distance from the string to the finger board is not reduced.

FIG. 16 shows the bridge 121 of a cello and a bridge support 120 designed according to the invention both in front view and in diagonal view. A bridge support 120 according to the invention can be punched from a thin steel sheet and can then be bent in a way so as to form the string groove 122. Such a bridge support 120 can be glued to the bridge 121, in particular using bone glue. In principle, it is also feasible to produce such bridge supports 120 by working off metal pieces mechanically.

FIG. 17a is schematic illustration of a mute 125 for string instruments. Such mutes 125 are placed onto the bridge 126 of the string instrument when playing said instrument. Due to the design according to the invention of such mutes, the advantages are achieved which have already been described for the previously described parts.

According to FIG. 17a, a play mute 125 and, according to FIG. 17b, a practice mute comprising a heavy metal insert 128, in particular made of tungsten and/or iridium and/or an alloy of said metals, are placed onto a cello bridge 126.

Such a play mute or practice mute 127, i.e. with or without an insert 128 acting as a weight, is located firmly especially due to the low E-modulus of the metals used and does not become detached easily, not even as a result of vibrations.

Bow windings (not illustrated) for string bows can be designed in the manner according to the invention; instead of solid wires made of nickel silver, silver or gold, wires or strips made of titanium or titanium grade 5 or the corresponding alloys, respectively, if need be, in combination with hard layers, are used on the bow rod for protecting the rod and for providing safe support. The wear resistance, the corrosion resistance and the skin tolerance of these materials are important especially in this case. The bow winding, in particular the wire, can be designed in a round or semi-oval fashion or as a milled or unmilled flat strip or plait. Due to the low density of the materials used, the balance of the bow is influenced positively.

Organ pipes (not illustrated) are produced according to the invention from the indicated materials, i.e. titanium or titanium alloys, if need be, coated with at least one hard layer, whereby corrosion resistance is provided, and—in contrast to conventional pipes consisting of soft materials—stability of the tone pitch is ensured.

FIG. 18 shows a face 130 for string bows. Usually, faces 130 are produced from nickel silver, silver, gold, ivory, mammoth ivory or plastic and mounted on the bow head 131 in order to protect the head and provide balance. Since these materials are soft or brittle, respectively, the faces must be remanufactured again and again. In addition, the vibrations of the bow rod 132 are damped as well. Via the production and use of bow faces made of titanium or a titanium alloy such as titanium grade 5 or material numbers 3.7165 and 3.7164 (TiAl6V4), respectively, optionally in combination with a PVD coating of TiN, WC/C, CrC and/or CrN, and the possibilities of anodic oxidation and thermal treatment, a much better vibration behaviour of the bow rod 132, better playability, a more brilliant tone and a longer durability of the bow are achieved, besides all the advantages of titanium or titanium alloys.

The wear resistance and corrosion resistance of the bow face 131 made of titanium or a titanium alloy is almost boundless. In addition, the material and the coatings are inert and non-abrasive.

Due to the low density, the balance of the bow will also be influenced positively. A wedge is pressed into the face which is subjected to enormous strain against which titanium or titanium alloys offer sufficient resistance. The axial reflection of the rod is promoted by the high strength and sound conductivity of titanium without weighing too heavily in the head area.

A tailpiece 135 as schematically shown in FIG. 19 is usually subject to quick wear and causes substantial damping of vibrations and upper harmonics. According to the invention, the parts of such tailpieces, in particular for string instruments, comprising integrated fine tuners are produced at least partially from titanium or from the alloys indicated according to the invention, respectively, if need be, provided with hard layers. Advantageously, said parts are produced by machining. However, the bush 136 which is provided is manufactured especially from cold-drawn bronze for bearings and bushes. The tailpiece 135 is advantageously manufactured from ebony, boxwood or rosewood. Said tailpiece has two bores per string, with the larger bore receiving the lever 137 comprising the lever sleeve 138 and the articulated pin 139. The lever 137 is characterized by a string slot 140 and a shuttle-shaped guide recess 141. The smaller bore receives the bronze for bearings and bushes with an internal thread, which in turn supports the adjusting screw 143, which bronze is pressed into a sleeve 142 made of titanium or an alloy according to the invention, respectively, which, if need be, is provided with hard layers. Up to eight holes are drilled into a tailpiece, into which holes the bushes or sleeves 142, respectively, designed according to the invention are then pressed. Thus, at least the bushes and, if necessary, also the parts 135 and/or 143 and optionally the parts 144 and 137, are manufactured from titanium or from the titanium alloys according to the invention, respectively.

FIG. 20 shows a thumb or finger ring 145, in particular for plucked instruments. Such rings serve for plucking or striking the strings. If such rings are manufactured according to the invention from titanium or from the titanium alloys according to the invention, respectively, if need be, coated with hard layers of the indicated kind, there is a better vibration transmission to the strings as well as a more brilliant tone and the period of vibration of the strings is much longer. The upper harmonics and hence the transparency of the acoustic patterns are influenced favourably. Such rings are wear resistant and corrosion resistant as well as inert and non-abrasive.

FIG. 21 shows a bottleneck 146 for plucked instruments. Such a bottleneck is designed in the same way as the previously described rings; the materials used and the envisioned design according to the invention basically yield the same advantages.

FIG. 22 shows a frog 150 as well as buttons for string bows. The web 151, the frog ring 152, a gusset 153 and button rings 154 are usually produced from nickel silver, silver or gold and are attached to the frog and the button and subsequently to the bow. Since these materials are soft and vibration-reducing, these small parts, especially at least one or several of these small parts, are produced from titanium or from a titanium alloy provided according to the invention, if need be, coated with at least one hard layer. A far better vibration behaviour of the bow rod and hence better playability and a more brilliant tone as well as a longer durability of the frog and of the button are achieved. Due to the low density of the materials used, the balance of the bow is influenced positively.

The frog ring is subjected to enormous strain during the attachment of the hairs, since the hairs are inserted in the ring with a wedge; titanium and the titanium alloys used, respectively, offer enough resistance toward said strain. The axial reflection of the bow rod is promoted by the high strength and sound conductivity of titanium or of the alloys used, respectively, without weighing too heavily in the frog area.

FIG. 23 shows a bell 160 as it can be provided, for instance, in a carillon, or can be suspended from the frame of a carillon, respectively. However, such bells can also be used for other applications, for example, as church bells. Bells are roughly rotationally symmetrical workpieces 161 which are activated by a clapper or beater 162, by means of which the inner or outer surface of the bell 160 is struck. The bell 160 is suspended from the yoke with ropes. The ropes are threaded through the crest 163. In case of bells 160, the clapper 162 and/or the bell is/are swung using various devices in order to trigger the sound on the rim 164 upon impact, whereby the bell is set into vibration.

According to the invention, the bell 160 and/or the clapper 162 is/are produced from titanium or from a titanium alloy provided according to the invention, if need be, coated with at least one hard layer. As with all other previously described parts, a heat treatment can be provided. Apart from the lightness of such a bell 160, it can easily be set into vibration and has a brilliant tone rich in upper harmonics. The duration of the chime and of the lingering sound, respectively, can be doubled, and the sound volume of the bell increases substantially. With the employed titanium alloy or titanium, respectively, the risk of fracture is much smaller than with the bronze or brass which is usually used.

FIG. 24 shows a string bow screw 170 for string bows. Such string bow screws consist of a round metal rod which, on one end, has a square 171 for receiving the knob or the button. An opposed thinner end serves as a bearing pin 172. The string bow screw 170 has a bearing surface 173 and in the centre a thread 174 on which a nut runs. The thread is a metric or imperial thread. The two bearing surfaces 173 are shaped slightly conically; also the bearing pin 172 is shaped conically. This produces an optimum transmission of vibrations. If a trapezoidal thread 174 or a round thread is used, the durability of the bow is increased and the bow can be tightened with little effort, since the flank has only 30°, rather than 60° as with metric threads or 55° as with imperial threads. Furthermore, the flank friction is substantially lower in a thread of 30° or less than with steeper flanks.

Instead of titanium and titanium alloys, tungsten and/or iridium or alloys of these metals, if need be, also platinum-iridium alloys, are used as materials for the string bow screw. The reason therefor is that the end of the bow rod receives the screw in an axial manner and, due to the high density of the screw (of approx. 17.5 to 22.65 kg/dm³), permits a far more intensive axial flection of the bow rod than in a situation with less weight applied. In addition, the balance of a lightweight bow, especially of antique French bows, can be modified and adjusted very easily by replacing the screw. If the heavy metal alloy of the screw exhibits an appropriate sound conductivity and hardness, the upper harmonics are not damped and the bow has a fuller and louder tone and the grip of the bow hairs and hence the playability as well as slightly trembling bows can be offered to a user in improved versions. The vibration behaviour of the bow screw is influenced in a well audible manner by one or several superimposed layers such as TiN, WC/C, CrC, CrN. These layers are applied onto the screw via PVD processes and reduce the coefficient of friction to a substantial extent, whereby the nut obtains a longer durability.

FIG. 25 shows a bassoon tube 175 which, according to the invention, is manufactured from titanium, in particular titanium grade 5, or from an indicated titanium alloy, optionally provided with at least one of the indicated hard layers, in particular hard layers produced by PVD coating, and which, if necessary, has been anodized and/or treated thermally in order to optimize the hardness and the modulus of elasticity, respectively. Such a bassoon tube 175 has substantial wear resistance and corrosion resistance; said bassoon tube 175 is inert and non-abrasive and displays a brilliant tone. Furthermore, the low density of the alloys used as well as the allergenic behaviour of said alloys have a positive effect.

A tuning fork 176 according to the invention, as illustrated, for example, in FIG. 26, is produced from the same materials as the previously indicated bassoon tube. The treatment of the specified materials and alloys, respectively, can be effected in the same way. Besides the above-described advantages, the tone can be heard better and longer because of the abundance of upper harmonics of the tuning fork. This applies to tuning forks in all frequency ranges, with or without a resonance body.

The tuning pipes 177 schematically illustrated in FIG. 27 are likewise produced from the same materials as the bassoon tubes and tuning forks, respectively, and are subjected to the appropriate above-described treatments. Besides the above-described advantages, the vibration behaviour of the tuning pipe is influenced in a well audible and pleasant way. This applies in particular to tuning pipes in all frequency ranges, both to individual tuning pipes and to a row of several tuning pipes.

FIG. 28 shows an endpin 180 for cello and contrabass. An endpin 1 is a substantially rotationally symmetrical pivoted part made of wood or plastic, comprising a fixable metal rod which supports the cello or the contrabass when the instrument is played and, at the same time, receives the tailpiece fastener in a groove.

The wooden endpin part is inserted into a conical hole in the bottom block of a cello or contrabass in order to then produce the tension of the strings on an instrument by means of the tailpiece fastener, the tailpiece and the strings. Presently, all wooden endpin parts (FIG. 28) for celli and contrabasses are produced and sold in such a way that a collar or small ring 182 is provided at the end of the conical shaft 181 of the wooden part.

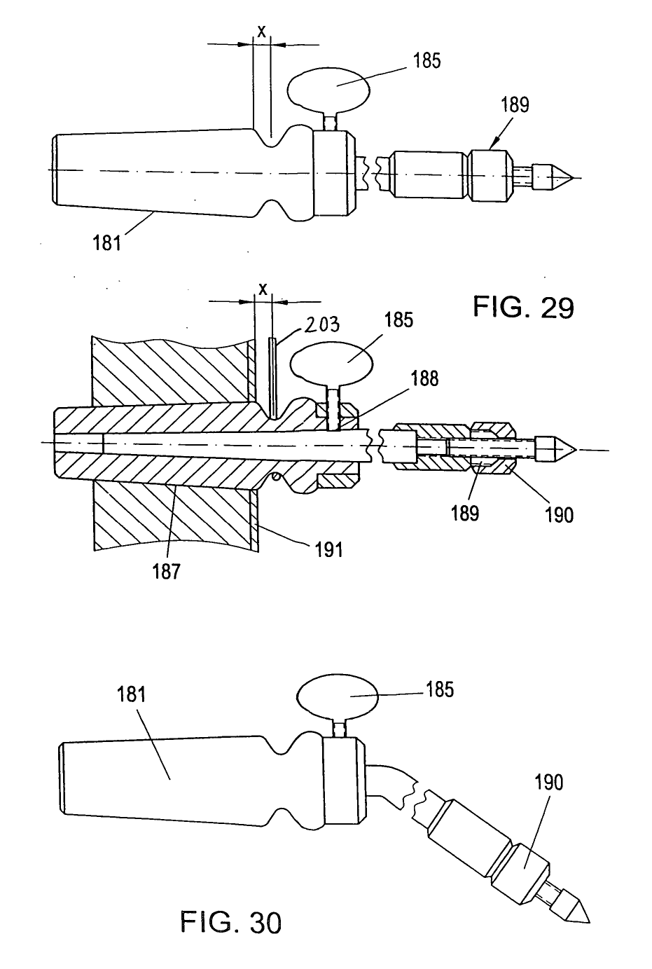

In contrast to conventional endpins (FIG. 28 and section of FIG. 28), the invention is based on the fact (FIG. 29 and section of FIG. 29 and FIG. 30) that the collar or small ring 182 is omitted entirely and the round groove 183 for the tailpiece fastener is placed directly after the conical shaft 182.

Normally, the rod 184 of the endpin is inserted into a cylindrical hole and is fastened with the wing set screw 185 which has the opposing thread in the ring 186.

In the invention, the wooden part receives the rod 184 in a cone 187. In this way, an equally firm seat of the rod is produced, irrespective of moisture or dryness, which seat can also be bent (FIG. 30) and transmits the vibrations much better. Furthermore, it is ruled out completely that the rod might slip under strain.

The rod 4 is likewise retained by a wing set screw 185 which presses down on a small area 188 milled into the cone. The invention has the disadvantage over conventional endpins that the rod can no longer be lowered into the instrument and hence is no longer height-adjustable in the wooden part, but the acoustic result is unmatched.

Height adjustment is effected at the tip of the rod by screwing or unscrewing the tip which is clamped by a slotted collet chuck 189 and a spigot nut 190.

In addition, acoustic advantages are provided if the material wood or plastic for the wooden endpin part, the rod, the ring, and the set screw is replaced by titanium or a titanium alloy, due to the vibration fatigue limit and density of the material.

If titanium or a titanium alloy is used for one or several part(s) on an endpin, it is occasionally feasible to provide coatings of titanium nitride, tungsten carbide carbon, chromium carbide or chromium nitride in order to differentiate the sound.

In case of the wooden endpin part according to the invention (FIG. 29), the distance “x” from the centre of the tailpiece fastener to the ribs 191 (section of FIG. 29) is much smaller and allows the rubbing of the wooden part in such a way that the tailpiece fastener leading via the bottom saddle to the tailpiece runs parallel to the ribs 191.

Omitting the collar 182 has two decisive advantages, first of all, it is possible only without a collar to provide firm support for the conical shaft 181 of the wooden endpin part, as the insertion is not limited by the collar and, secondly, the parallelism of the tailpiece fastener to the ribs is possible only without a collar. The firm seat of the conical shaft 181 is necessary for a better vibration transmission and a better support, and the parallelism of the tailpiece fastener to the ribs makes sure that the cover of the instrument is not upset excessively and the bottom of the instrument is not tightened excessively.

Especially in case of antique celli and contrabasses, the protruding bottom edge and cover edge is of course worn out during use, necessitating that distance “x” be reduced.

This results in a far more freely vibrating instrument, having a larger tone which is richer in upper harmonics. The instrument can also be played more easily due to an easier response.

In addition, the entire instrument, in particular the bottom and the cover, is deformed far less over time.

FIGS. 31 and 32 show a button 200 for a violin and a viola. The button 200 is inserted into a conical hole 201 in the bottom block 201 of a violin or viola in order to then produce the tension of the strings on an instrument by means of the tailpiece fastener, the tailpiece and the strings.

Presently, all buttons (FIG. 31) for violins and violas are produced and sold in such a way that a collar or small ring 204 is provided at the end of the conical shaft.

The button 200 is also provided with a ball 205 as a decoration. In contrast to conventional buttons (FIG. 31), the invention is based on the fact that the collar or small ring 204 is omitted entirely and the round groove 207 for the tailpiece fastener 203 is placed directly after the conical shaft 206.

In addition, acoustic advantages are provided if the material wood or plastic for the button is replaced by titanium or a titanium alloy, due to the vibration fatigue limit and density of the material. If titanium or a titanium alloy is used, it is occasionally feasible to provide coatings of titanium nitride, tungsten carbide carbon, chromium carbide or chromium nitride in order to differentiate the sound.

In case of the button according to the invention (FIG. 32), the distance “x” from the centre of the tailpiece fastener to the ribs 208 (section of FIG. 32) is much smaller and allows the rubbing of the button in such a way that the tailpiece fastener 203 leading via the bottom saddle to the tailpiece runs parallel to the ribs 208.

Omitting the collar 204 has two decisive advantages, first of all, it is possible only without a collar to provide actual support for the conical shaft of the button, as the insertion is not limited by the collar 204 and, secondly, the parallelism of the tailpiece fastener 203 to the ribs is possible only without a collar 204.

The firm seat of the conical shaft 206 is necessary for a better vibration transmission and a better support, and the parallelism of the tailpiece fastener 203 to the ribs 208 makes sure that the cover of the instrument is not upset excessively and the bottom of the instrument is not tightened excessively.

Especially in case of antique violins and violas, the protruding bottom edge and cover edge is of course worn out during use, necessitating that distance “x” be reduced.

This results in a far more freely vibrating instrument, having a larger tone which is richer in upper harmonics. The instrument can also be played more easily due to an easier response.

In addition, the entire instrument, in particular the bottom and the cover, is deformed far less over time.

A valve 210 according to the invention for brass instruments according to FIGS. 33, 34 and 35 consists of titanium, in particular titanium grade 5, if necessary, of the titanium alloys indicated according to the invention, especially in combination with coatings, especially coatings of TiN, WC, CrC and/or CrN produced according to the PVD process. Furthermore, colouring is feasible by anodic oxidation or thermal treatment or by hardening the alloys, respectively. By means of a valve 210 designed according to the invention, a better vibration transmission and a more brilliant tone are achieved, and the damping of impulses and upper harmonics is reduced, whereby an easier response of the instrument is rendered possible. At the same time, the possibility arises to increase the speed of the tone alternation, thereby improving the wear resistance of the valve. A more precise and durable pipe of the valves is achieved by thermal treatment and the hardening associated therewith and the possibility of grinding the fits of the parts to be matched or the workpiece, respectively, and of drastically reducing the coefficient of friction via the hard layers and coatings, respectively. It is likewise possible to change the design of the valve, since the employed alloys or the titanium, respectively, are far more solid and stable than brass alloys, which also results in a weight reduction to approximately one third of the original mass, which, in turn, permits a faster tone alternation. In a valve, especially the pivoted part and/or the valve flap and/or the guide are designed according to the invention.

In general, the material used and the coatings, respectively, are inert and non-abrasive as well. The hard layers do not only contribute to an increase in strength and stability but also influence the vibration behaviour of the material in an audible and pleasant way. Due to the poor heat conductivity of the materials used, is it possible to play the instrument with ease also in cold weather and/or in the open air. It is likewise possible to influence undesired vibrations on the cap using material combinations such as tungsten and/or iridium and/or alloys of these metals by applying them appropriately. It is important especially for valves 210 and for trombone slides and also in general that, if titanium grade 5 is used in all areas where titanium rubs or runs on titanium, rubbing is to be avoided by coating or material pairing with cold-hammered bronze for bearings and bushes, and not by grease, since grease would dampen the transmission of vibrations. Agglutinations are to be avoided as well.

The valve 210 according to the invention is usable for all kinds of valves or valve machines, regardless of whether the valve is a sliding valve (FIG. 33 and FIG. 34) or a rotary valve (FIG. 35) etc.

In FIG. 33, the cap 211, the piston 212 with the bores, the closure part 213, the spring guide 214, the spring 215, the outer tube 216 as well as the spacers 212 can be seen. FIG. 35 shows the pivoted parts 218 and 219 more precisely. Especially the parts 218 and 219 are designed according to the invention.

Commercially available tailpieces 222 for string instruments are made of wood and are shown in FIG. 36 in bottom view and in section A-A. Normally, they have four passing holes 223 and four passing slots 224 so that the string 225 can be secured and tightened with the string ball 226.

In this way, the string 225 is bent above the small ring 227 and on the edge 228. The invention is based on the fact that, in the tailpiece (FIG. 37 bottom view and section B-B and FIG. 38 top view), the string 225 is hooked with the string ball 226, preferably made of titanium or a titanium alloy, into a blind hole 229 having a conical groove 230.

In this way, the string is not unnecessarily bent twice but runs directly from the abutment of the string ball to the bridge.

As far as the conical groove 230 is concerned, it must be made sure that the string is exposed, since otherwise it might rattle.

The wood used is ebony, boxwood or rosewood.

If a fine tuner is required on one or several strings, the blind hole must be drilled through and a fine tuner, preferably made of titanium or a titanium alloy, is to be used.

The playability and quality of sound are audibly improved, since the vibratory characteristics of the ball and of the string are not hampered but transferred via the bridge directly to the cover.

Commercially available bridge saddles and neck saddles for plucked instruments are manufactured from ebony, bones, ivory or plastic.

If the bridge saddle 235 produced in FIG. 39 and the neck saddle 236 illustrated in FIG. 40 are manufactured from titanium or a titanium alloy such as titanium grade 5 having material number 3.7165 or 3.7164 (TiAl6V4), respectively, in combination with a coating produced by a PVD process of TiN, WC/C, CrC, CrN and the possibilities of anodic oxidation and thermal treatment, a far better vibration behaviour of the saddles and hence a much longer period of vibration as well as a more brilliant tone are achieved, besides all the advantages of titanium or a titanium alloy.

The wear resistance and corrosion resistance of the saddles 235, 236 made of titanium or a titanium alloy is almost boundless. In addition, the material and the coatings are inert and non-abrasive. The vibration behaviour of the saddles is influenced in a well audible and pleasant way by one or several superimposed layers such as TiN, WC/C, CrC, CrN.

As a result of the abundance of upper harmonics of titanium saddles, the tone is better and moreover the tone is audible for a longer period of time due to the good vibration behaviour.

It is likewise possible to produce the saddles from quartz glass (silicon oxide, SiO2), since, similarly to titanium grade 5, a long-lasting vibration with a very low damping effect is provided.

Both titanium or a titanium alloy and quartz glass are highly polishable, involving a high surface quality in the string grooves 237 and, associated therewith, a long durability of the string.

The playability and quality of sound are audibly improved, since the vibratory characteristics of the string are not hampered but transferred via the bridge and the neck directly to the instrument.

A commercially available wooden bridge 240 for plucked instruments, which is illustrated in FIG. 41 in top view and in section A-A, is provided with six of the required passing horizontal holes 241 for the number of strings, so that the string 242 can be secured and tightened with the string ball 243. The string 242 may also be fastened with knots. In this way, the string 242 is bent on the edge 244 at the end of the horizontal bore 241.

The invention is based on the fact that, in the bridge 240 according to FIG. 42, which is illustrated in top view and in section B-B, the part 245, the string 242 with the string ball 243 made of titanium or a titanium alloy is hooked into a sloped larger hole 246.

In this way, the string 242 is not unnecessarily bent but runs directly from the abutment, the string ball or the knot to the saddle 247.

Regarding the sloped larger bore 246, it must be made sure that the string 242 is exposed, since otherwise it might rattle.

The wood used is ebony, maplewood or rosewood.

The playability and quality of sound are audibly improved, since the vibratory characteristics of the ball 243 and of the string 242 are not hampered but transferred via the bridge 247 and the bridge saddle directly to the cover.

1. Accessory and component and actuating parts, respectively, for and of musical instruments, respectively, characterized in that said parts are formed at least partially. preferably entirely, from titanium or a titanium alloy GRADE 5, preferably TiAI6V4, or from a titanium alloy of material number 3.7165 or 3.7164. respectively.

2. Parts according to claim 1, characterized in that the titanium and the titanium alloy, respectively, are provided in a molten, forged or sintered form.

3. Parts according to claim 1, characterized in that the parts are coated with at least one layer or hard layer, respectively, made of WC/C (tungsten carbide carbon) and/or WC and/or CrC (chromium carbide) and/or CrN (chromium nitride), which preferably are deposited or applied, respectively, in the course of a physical application process, in particular a PVD process.

4. Parts according to claim 1, characterized in that a surface coating or a hard layer, respectively, made of titanium nitride is formed On or applied to the parts.

5. Pans according to claim 1, characterized in that, for colour mg. the surfaces of the pans are electroplated and/or coated with platinum, gold or rhodium or anodized, respectively.

6. Parts according to claim 1, characterized in that the parts are subjected to a thermal treatment or are hardened thermally, respectively.

7. Parts according to claim 1, characterized in that the parts are prepared by machining.

8. Parts according to claim 1, characterized in that the titanium and the titanium alloy, respectively, have a density of about 4.42 g/cm² and a tensile strength of at least 820 N/mm².

9. Parts according to claim 1, characterized in that the accessory and component and actuating parts, respectively, are at least one of the following parts:
a fine tuner for string instruments, in particular the screw connection part and/or knurled nut and/or lever and/or knurled screw and/or microscrew thereof,
a string ball,
a tailpiece fastener and/or a fixing part for a tailpiece fastener,
a wolf eliminator. in particular the screw sleeves thereof,
a peg, preferably a peg for string instruments, in particular a peg shaft,
a tuning peg, in particular for keyboard instruments, harp, zither, dulcimer and raffele,
a mouthpiece for brass instruments,
a bridge pin, in particular for keyboard instruments,
a string for string instruments,
a fret, in particular for plucked instruments,
a sound piece for brass instruments and a bell mouth, respectively, for hooters, signal-horns or horns,
a chin holder screw, in particular for violin and viola,
a plectrum, in particular for plucked instruments,
a mechanism for plucked instruments, in particular contrabasses.
a trombone slide,
a valve for brass instruments,
a lamina, in particular for vibraphone or metallophone,
a tongue for harmonicas, in particular accordions and mouth organs, and for musical clocks, automatic pianos, respectively,
a sheet or tone sheet, respectively, preferably for woodwind instruments or saxophone,
a bridge support, in particular for string instruments,
a mute for string instruments,
a bow winding for a string bow,
an organ pipe,
a face for a string bow,
a tailpiece or tailpiece sleeve, respectively,
a thumb ring,
a bottleneck, in particular for plucked instruments,
a frog and/or a button for a string bow as well as a frog, a ring, a gusset or a button ring,
a bell,
a bassoon tube,
a tuning fork,
a tuning pipe,
an endpin for string instruments,
a button for string instruments,
a bridge for plucked instruments,
a saddle for plucked instruments,
a tailpiece for string instruments,
valves for wind instruments.

10. A wolf eliminator for string instruments according to claim 1, characterized in that pure iridium or pure tantalum is used as a material for the collet chuck (26).

11. A peg for string instruments according to claim 1, characterized in that at least the peg shaft (31) is formed from titanium or a titanium alloy, respectively, wherein the shaft is optionally connected or glued, respectively, to a wooden peg (30).

12. A peg for string instruments according to claim 1, characterized in that the shaft (31) is thinned between the pegbox walls (33).

13. A peg for string instruments according to claim 1, characterized in that fine threads (34) are formed on the bearing surfaces of the peg.

14. A peg for string instruments according to claim 1, characterized in that two overlapping threads (34), in particular a right-hand and a left-hand thread, are formed in the area of the bonding sites between the metallic peg shaft (31) and the wooden cap (30) placed onto the same.

15. A tuning peg for keyboard instruments according claim 1, characterized in that the peg shaft (31) exhibits a multi-start fine thread.

16. A mouthpiece for brass instruments according to claim 1, characterized in that the mouthpiece (60), in particular in the area of the heart and the soul (63, 64), has a ring (67) made of iridium, tantalum or tungsten or alloys thereof. which ring has been inserted, in particular hot-pressed, or attached or in particular wound on in the hot state.

17. A fret for plucked instruments according to claim 1, characterized in that the fret (50) comprises retaining teeth (54, 55) in the shaft area (53).

18. A tuning peg for keyboard instruments, harps, zithers. dulcimer and raffele according to claim 1, characterized in that the tuning peg comprises a rolled or milled thread (43) for insertion in the instrument.

19. A chin holder screw for string instruments, in particular violins, violas or the like according to claim 1, characterized in that the inside thread part (77) has three radial bores (80).

20. A chin holder screw according to claim 1, characterized in that the foot (81) is released in order to protect the edge.

21. A chin holder screw according to claim 1, characterized in that the internal threads, i.e. the left-hand thread and the right-hand thread, are covered by an initial clearance of the thread (78) in the inside thread part (77).

22. A mute for string instruments according to claim 1, characterized in that, in particular for the design of a practice mute, the mute (125) carries at least one insert made of a heavy metal (128), preferably tungsten or iridium or an alloy of said metals.

23. An endpin for cello and contrabass according to claim 1, characterized in that the material used is titanium or a titanium alloy at least for the individual parts of the endpin (180), preferably for the entire endpin.

24. An endpin for cello and contrabass according to claim 23. characterized in that the wooden endpin part is designed without a collar or small ring.

25. An endpin for cello and contrabass according to claim 23, characterized in that the conical shaft (181) of the wooden part is designed without a limitation or collar or small ring, respectively.

26. An endpin for cello and contrabass according to claim 1, characterized in that the conical shaft (181) of the rod (184) is received in the wooden pan.

27. An endpin for cello and contrabass according to claim 1, characterized in that the adjustable tip is clamped by means of a collet chuck (189) and a spigot nut (190).

28. An endpin for cello and contrabass according to claim 1, characterized in that the endpin (180) or parts thereof is/are coated with titanium nitride, with tungsten carbide carbon, with chromium carbide and/or with chromium nitride, in particular according to the PVD process.

29. An endpin for cello and contrabass according to claim 1, characterized in that the endpin (180) comprises a bent or folded rod (184), respectively.

30. An endpin for cello and contrabass according to claim 1, characterized in that the groove (183) for the tailpiece fastener (203) is formed as a recess directly adjacent to the shaft (181).

31. A button for violin and viola according to claim 1, characterized in that the material used in particular for the entire button (200) is titanium or a titanium alloy.

32. A button for violin and viola according to claim 31, characterized in that the button (200) is designed without a collar or small ring.

33. A button for violin and viola according to claim 31, characterized in that the conical shaft (206) is designed without a limitation or collar and small ring, respectively.

34. A button for violin and viola according to claim 31, characterized in that the button (200) is coated with titanium nitride, with tungsten carbide carbon. with chromium carbide and/or with chromium nitride, in particular according to the PVD process.

35. A button for violin and viola according to claim 31, characterized in that the groove (207) for the tailpiece fastener (203) is formed as a recess directly adjacent to the shaft (206).

36. A valve for brass instruments according to claim 1, characterized in that at least one of the components, namely cap (211), piston (212), closure part (213), spring guide (214), spring (215). outer tube (216). spacers (217) and/or pivoted parts (218, 219), is formed from titanium or a titanium alloy, preferably TiAl 6V4.

37. A valve according to claim 36. characterized in that the components are coated with titanium nitride or tungsten carbide carbon or chromium carbide or chromium nitride arid/or electroplated or heat-treated.

38. A tailpiece according to claim 1, characterized in that, in order to fix the string (225) with a string ball (226), a blind hole (229), in particular with a conical groove (230), is formed in the tailpiece, into which blind hole the string ball (226) can be hooked.

39. A bridge according to claim 1, characterized in that, in order to fix the string (242) with the string ban (243), a sloping hole (246) is formed in the bridge (240), which hole is directed in particular toward the upper edge of the saddle (247) and whose discharge opening, respectively, is located on the level of the saddle (247).

40. The use of titanium or a titanium alloy GRADE 5, preferably TiAl6V4, or of a titanium alloy of material number 3.7165 or 3.7164, respectively, for the parts according to claim 9, wherein the parts are optionally coated with at least one layer or hard layer, respectively, made of WC/C (tungsten carbide carbon) and/or WC and/or CrC (chromium carbide) and/or CrN (chromium nitride) and/or have a surface coating made of titanium nitride.
